(19) United States
(12) Patent Application Publication
(10) Pub. No.: US 2022/0161074 A1
(43) Pub. Date: May 26, 2022

(54) AUTOMATED FIRE OR SMOKE CURTAIN SYSTEM

(71) Applicant: Ashit Padhya, Ghatlodia, Ahmedabad Gujarat (IN)

(72) Inventor: Ashit Padhya, Ghatlodia, Ahmedabad Gujarat (IN)

(21) Appl. No.: 17/441,956

(22) PCT Filed: Jan. 25, 2020
(86) PCT No.: PCT/IB2020/050586

§ 371 Date: Sep. 22, 2021

(30) Foreign Application Priority Data
Mar. 24, 2019 (IN) 201921011373

(51) Int. Cl. A62C 2/10; E06B 9/13; E06B 9/72

(52) U.S. Cl. CPC A62C 2/10; E06B 2009/6818; E06B 9/72; E06B 9/13

(57) ABSTRACT

An automated fire or smoke curtain/blinds system (2) includes a pelmet or a hood (4) adapted to be mounted on a wall or top of a windowpane, at least one motor (6) connected to at least one curtain/blinds holding device (10) such that the curtain/blinds 5 holding device (10) rolls when the motor (6) is operated, at least two curtain/blinds holding device wherein each curtain/blinds holding device are connected by a shaft or ball bearing, a movable curtain or blind with width of at least 8 meters attached to at least two curtain/blinds holding device, a movable curtain or blind (14A) of a predefined width and at the end of which is a bottom rail (14B), wherein the movable 10 curtain (14A) includes an self-closing escape door (14C) embedded within coverage area of the movable curtain (14A), and a control panel (16) to control up/down movement of the movable curtains.

### BACKGROUND

### Technical Field

The embodiments herein generally relate to an automated fire or smoke curtain system and more particularly to, an automated dropdown control system with a curtain or blinds of more than 8 meters. In one embodiment, the curtains of the present disclosure provide a self-closing escape route during an emergency situation. In one embodiment, the curtain or blinds of present invention are capable of quicker drop of curtain with more than 5 meters height.

### Description of the Related Art

Electric curtains generally comprise a flexible fabric for covering a window or to limit or other means to block sunlight entering the space and provide privacy. Electric curtains may include, for example roller blinds, Roman blinds or drapery. The motorized window comprises a window in front of the moving web to control the amount of the windows are covered with a fabric of a motor drive. For example, typical electric roller shade includes a shade fabric wound on to the flexible elongated roller tube, the roller tube is mounted in an electronic drive unit. The electronic drive unit comprises an electric motor such as a direct current (DC) motor or the like, which is operable to rotate the roller tube when excited by a DC voltage.

In the existing system, there are two types of operational set up first is the single barrel system where the curtain can be of maximum width of 7.5 meters. The hood box or pelmet for same may be of dimensions 200 mm×200 mm. Second is the double barrel system, in which the curtains will have overlap at every 6-6.5 meters depending on width and height (including weight) for the system. The hood or pelmet size will be in the dimensions 200 mm×400 mm (height). At most of the sites height of 400 mm is an issue, due to space limitation for fixing the hood. Apart from space issue, another problem is of overlap of 500 mm at every joint. Also, due to increase in number of motors, cost of system goes up. Many a times weight of the curtains or blinders is much less than capacity of the motor, therefore new or less capacity motor is to be used due to limitation of width. In situations where the height is less, the hood box required will have the same dimensions and configurations. Also, when curtains are having longer lengths there is no escape route possible as the operating switch is at the end of curtain and the whole curtain has to be taken up for escape or passing through. Further, the escape route has to close down on its own.

Many a times due to special design curtains are required in L shape or nonlinear. The installation is required without side guides or vertical support at the end. To achieve the same, corner unit is installed at the junction and the minimum height required is 1000 mm, which is not always available at most sites. Besides, additional motor is required to achieve the same increasing the overall cost of the curtain system. Also, with space required for installing corner unit is 1000 mm, this increases load on the structure. Similarly, for square or rectangle curtains there are two limitations, first is it will have corner units and second the width cannot me more than 7 meters. For Zigzag curtains there are similar two limitations, first is that it will have corner units and second the width cannot me more than 7 meters.

Control panels which are usually installed near motors and mostly at a height and above false ceiling. This makes difficult to monitors its health. All the electrical connections and input signals are in the control panels. Due to use of batteries, which, needs replacement at regular interval increase cost. Only operating switch is installed at operable height, which is used only for up/down movements. Curtains are usually stitched vertically in most of these systems. Accordingly, there remains a need for an improved automated curtain system which can save space on the hood or the pelmet.

The system should also provide an efficient escape route and fire proofing of the curtains. Further, the curtain system should be able to be installed without much customization and cost escalation in any corners of the room irrespective of the shape of the walls where they are been mounted. The control panel used in such systems should also be easily accessible to a user while operating in normal and emergency situations. The system should be cost viable, efficient in operation and easily customizable depending upon the site usage.

### SUMMARY

The embodiment herein provides an automated fire or smoke curtain system. The system includes a pelmet or a hood adapted to be mounted on a wall or top of a windowpane, at least one motor connected to at least one curtain/blinds holding device such that the curtain/blinds holding device rolls when the motor is operated, at least two curtain/blinds holding device wherein each curtain/blinds holding device are connected by a shaft or ball bearing, a movable curtain or blind with width of at least 8 meters attached to at least two curtain/blinds holding device, and a control panel to control up/down movement of the movable curtains.

In an embodiment, the pelmet may be made of a stainless steel, mild steel, galvanized steel or metal sheet of varied designs. Here, the motor and the curtain/blinds holding device are mounted within the pelmet.

In an embodiment, the movable curtain includes a self-closing escape door which may be connected to each other through a magnet. The movable curtain or blinds may be assisted to roll up/down smoothly through a side guide which may be located at edges of the said curtains.

In one embodiment, the movable curtain is made from a fiber glass cloth or ceramic cloth or any other fire proof material but not limited to the embodiments mentioned herein. The control panel cum operating switch is having an arrangement for up/down movement switch along with override switch and facility for accepting potential free signal for automatic operation (FIG. 3). The control panel may include an LCD display which facilitates a user to control the curtain system. In an embodiment, the control panel may consist of facility to accept signal from fire alarm, a smoke detector, a temperature sensor and facility for customized drop and stop facility timed upto 9 steps. (FIG. 4 is also control panel with all above features).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments:

The embodiments herein will be better understood from the following detailed description with reference to the drawings, in which:

FIG. 1 illustrates a front schematic view of an automated fire or smoke curtain system according to an embodiment mentioned herein;

FIG. 2 illustrates a front schematic view of an automated fire or smoke curtain system depicting escape route in case of emergency according to an embodiment mentioned herein;

FIG. 3 illustrates a display unit of an automated fire or smoke curtain system according to an embodiment mentioned herein;

FIG. 4 illustrates a control panel unit of an automated curtain system according to an embodiment mentioned herein; and

FIG. 5 illustrates various arrangements in which the automated fire or smoke curtain system may be installed in a given premises according to an embodiment mentioned herein.

Persons skilled in the art will appreciate that elements in the figures are illustrated for simplicity and clarity and may not have been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF PREFERRED EMBODIMENTS

Although specific terms are used in the following description for the sake of clarity, these terms are intended to refer only to the particular structure of the invention selected for illustration in the drawings, and are not intended to define or limit the scope of the invention.

References in the specification to “one embodiment” or “an embodiment” member that a particular feature, structure, characteristics, or function described in connection with the embodiment is included in at least one embodiment of the invention. The appearances of the phrase “in one embodiment” in various places in the specification are not necessarily all referring to the same embodiment.

In the following description, for purposes of explanation and not limitation, specific details are set forth such as particular architectures, interfaces, techniques, etc. to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudo code, and the like represent various processes which may be substantially represented in computer readable medium and so executed by a computer or processor, whether such computer or processor is explicitly shown.

Accordingly, there remains a need for an improved automated fire or smoke curtain system which can save space on the hood or the pelmet. The system should also provide an efficient self-closing escape route and fire proofing of the curtains. The system should be cost viable, efficient in operation and easily customizable depending upon the site usage. Curtains should drop quicker for heights more than 4 meters, so as to prevent spread of fire.

In the present embodiment, system may contain ball bearing and MS strips on bigger rods to address weight issues along with quicker drop.

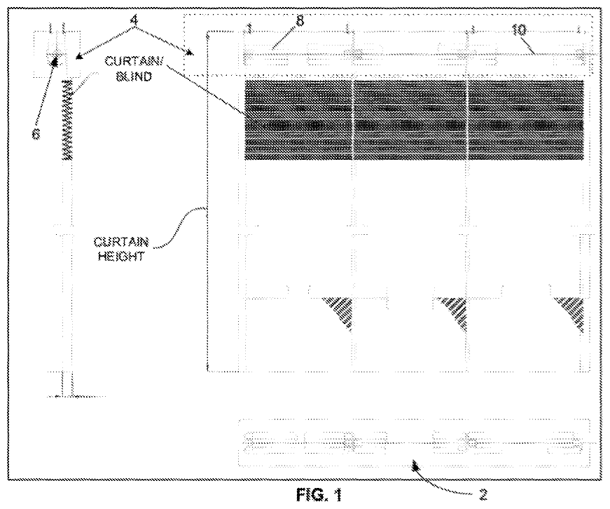

The present embodiments herein provide an automated fire or smoke curtain system. The curtains of the present disclosure are fire proof and also provides an escape route during an emergency situation. Here a user may be any user human or otherwise and referred to any person who may be controlling the automated fire or smoke curtain system directly or automatically. Referring now to the figures, more particularly from FIG. 1 to FIG. 4, where similar reference characters denote corresponding features consistently throughout the figures, preferred embodiments are shown.

FIG. 1 illustrates a front schematic view of an automated fire or smoke curtain system 2 according to an embodiment mentioned herein. Here the curtain system 2 may be mounted on any surface of wall in a room. More specifically the curtain system 2 includes a hood or a pelmet 4 which may be adapted to be mounted on the wall or top of the windowpane. In an embodiment, the pelmet may be made from a stainless steel, mild steel, galvanized steel or metal sheet which may endorse various patterns and designs.

In one embodiment, height of the hood or pelmet 4 is less than 250 mm. In an embodiment, the automated fire or smoke curtain system 2 further includes at least one motor 6. The motor 6 may be connected to the curtain/blinds holding device 10. In an embodiment, the curtain/blinds holding device 10 rolls when the motor 6 is operated in up/down position. In an embodiment, the curtain/blinds holding device 10 may be embedded within the pelmet 4. In an embodiment, the said at least one motor is AC motor or a DC motor.

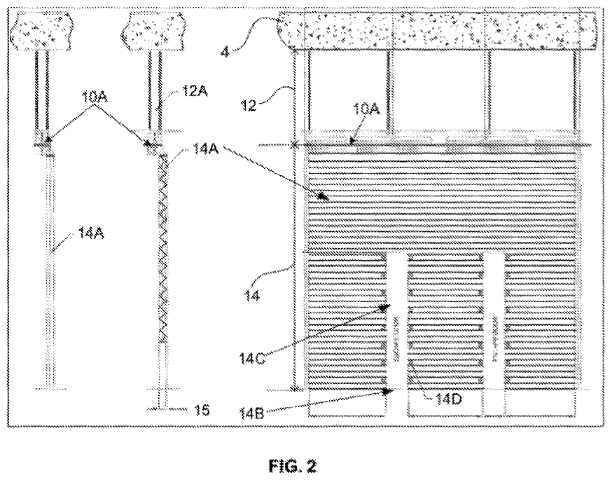

FIG. 2 illustrates a front schematic view of the automated curtain system 2 depicting escape route in case of emergency according to an embodiment mentioned herein. The automated curtain system 2 further includes at least two curtain/blinds holding device 10 wherein each curtain/blind holding device 10 are connected by a shaft or ball bearing 8 and a movable curtain or blind 14A with width of at least 8 meters attached to at least two curtain/blinds holding device.

In an embodiment, combination of at least two curtain/blinds holding device 10 and shaft/ball bearing forms a single barrel fire/smoke curtain/blinds system wherein width of curtain/blinds is at least 8 meters. In an example embodiment, said single barrel system can be pully-based system.

In an embodiment, the movable curtain 14A includes a self-closing escape door 14C embedded within coverage area of the movable curtain 14A.

In an example embodiment, the movable curtain 14A having the escape door 14C may be connected to each other through a magnet 14D. In an embodiment, the movable curtain 14A is assisted to roll up/down smoothly through a side guide 15. In an embodiment, the side guide 15 may be located at edges of the said curtain or blind 14A. The movable curtain 14A is made from a fiber glass cloth or ceramic cloth or any other fire proof material but not limited to the embodiments mentioned herein. In one embodiment said curtains or blinds are folded into stacked manner either horizontally or vertically.

In one embodiment, the automated fire or smoke curtain system as per invention contains more than one curtain/blind holding device arranged at the angle of at least 30 degrees at one or more places. The arrangement of multiple curtain/blind holding device can be L shaped, Z shaped, square shaped, rectangular shaped, zig zag shaped or at 45 degree.

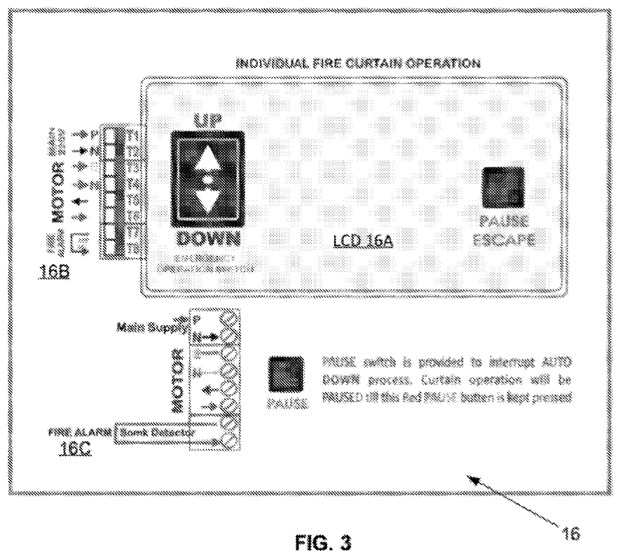

FIG. 3 illustrates a display unit of an automated fire or smoke curtain system according to an embodiment mentioned herein. In an embodiment, the automated fire or smoke curtain system includes a control panel 16 to control up/down movement of the movable curtains 14A. In an embodiment, the control panel 16 consists of an LCD display 16A which facilitates a user to control the curtain system 2.

In an example embodiment, the LCD display 16A may be located near to the mounted curtain system 2 or may be embedded in the wall surface or can be a connected to a wired or wireless device which is operated by an end user operating the automated curtain system 2. The curtain control panel 16 receives 240v ac in order to operate the curtain system 2 and if supported by inverter, keep the batteries charged up.

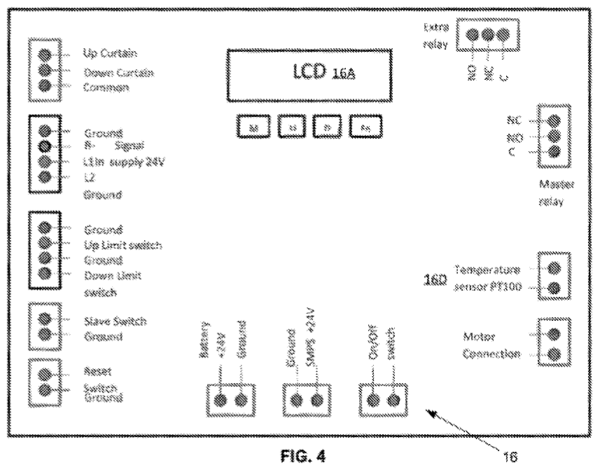

FIG. 4 illustrates the control panel 16 consist of facility to accept signal from a fire alarm 16B, a smoke detector 16C and a temperature sensor 16D and facility for customized drop and stop facility timed upto 9 steps. In an embodiment, few components of the control panel 16 may be located within the hood 4. For e.g. a fire alarm 16B, a smoke detector 16C and a temperature sensor 16D.

In an embodiment, direct or indirect 220v AC power is connected to the panel 16 for automatic operation of curtain Motor (UP and DOWN curtain). The control panel 16 will may communicate with independently supplied the alarm system 16B on the 220v AC system.

The curtain may complete the descent after being activated by the fire alarm 16B or any other signal and the curtain will be opened/UP immediately against deactivation of the alarm 16B. Manual switching may be provided for any emergency use/operation of UP/DOWN the curtains.

In normal use the curtains are retracted awaiting the alarm signal. The curtains wind down when they receive such a signal. After the curtains are fully down if anyone press Motor UP key switch then curtain starts to go up and after releasing Motor UP key curtain again start wind fully down.

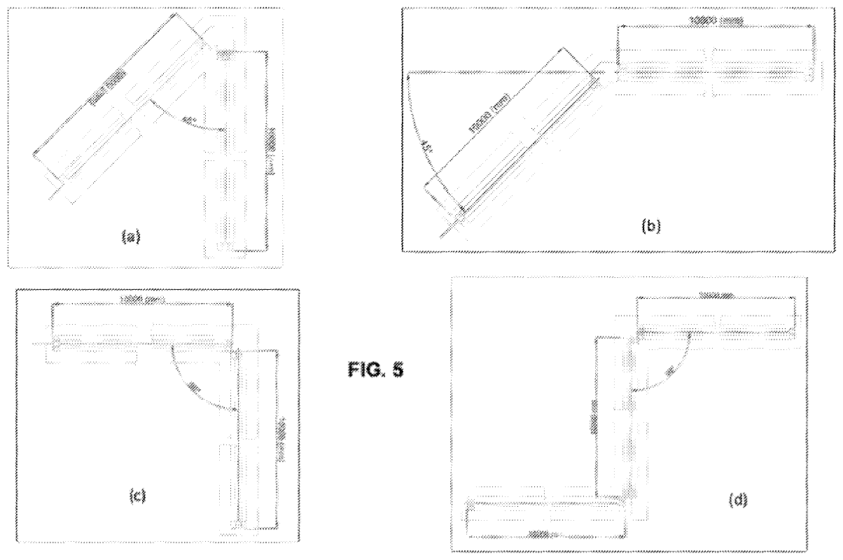

FIG. 5 illustrates various arrangements in which the automated fire or smoke curtain system may be installed in a given premises according to an embodiment mentioned herein. Here FIG. 5 (a) depicts a general arrangement of the curtain system 2 with L jointer and length extender having 45° angle from normal.

In an embodiment, FIG. 5 (b) depicts another arrangement of the curtain system 2 with L jointer and length extender having more than 90° angle from the normal. In another embodiment FIG. 5 (c) depicts yet another arrangement of the curtain system 2 with L jointer and length extender having 90° angle from the normal.

In an example embodiment, FIG. 5 (d) depicts Z type arrangement of the curtain system 2 with L jointer and length extender covering any zig zag area of the room or premises.

% Energy efficiency=(weight of curtain or blinds/weight bearing capacity of motor)*100

In an embodiment, energy efficiency of the system is greater than 70%. In another embodiment, energy efficiency of the system is greater than 80%.

The advantageous embodiment of the present disclosure once the curtain 14A has completed the descent after being activated by the fire alarm 16 or any other signal, only then the motor 6 operates to raise the curtain 14A and allow for an escape route under the curtain 14A. Thus, the embodiments of the present curtain system 2 provide an efficient escape route and fire proofing of the curtains.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. An automated fire or smoke curtain/blinds system (2) comprising:
a pelmet or a hood (4), wherein the pelmet is made of a steel or metal sheet of varied designs; at least one motor (6) connected to at least one curtain/blinds holding device (10), wherein the motor (6) and the curtain/blinds holding device (10) is mounted within the pelmet (4);
at least two curtain/blinds holding device wherein each curtain/blind holding device are connected by a shaft or ball bearing;
a movable curtain or blind with width of at least (8) meters attached to at least two curtain/blinds holding device (10);
a control panel (16) to control up/down movement of a movable curtain/blind (14A).

2. The system of claim 1, wherein the movable curtain/blind (14A) having the escape door (14C) is connected to each other through a magnet (14D).

3. The system of claim 1, wherein the movable curtain/blind (14A) is assisted to roll up/down smoothly through a side guide (15) which is located at edges of the said curtain/blind.

4. The system of claim 1, wherein the movable curtain/blind (14A) is made from a fiber glass cloth or ceramic cloth or any other fire proof material.

5. The system of claim 1, wherein the said curtain or blinds are folded in stacked manner horizontally.

6. The system of claim 1, wherein the control panel consist of an LCD display (16A) which facilitates a user to control the curtain/blind system (2).

7. The system of claim 1, wherein the control panel (16) consist of a fire alarm (16B), a smoke detector (16C) and a temperature sensor (16D).

8. The system of claim 1, wherein the said hood or pelmet (4) is of height less than 250 mm.

9. The system of claim 1, wherein said more than one curtain/blind holding device (10) are arranged at the angle of more than 30 degree at one or more places.

10. The system of claim 1, wherein said motor is an AC motor or DC motor.

11. The system of claim 1, wherein energy efficiency of the said system is more than 70%.

12. The system of claim 1, wherein said curtain/blinds holding device (10) is a solid rod or a multiple metal strip.
